(19) United States
(12) Patent Application Publication
(10) Pub. No.: US 2019/0030481 A1
(43) Pub. Date: Jan. 31, 2019

(54) SYSTEM AND METHOD FOR CAPTURING CARBON DIOXIDE

(71) Applicant: National Tsing Hua University, Hsinchu City (TW)

(72) Inventors: Le Quoc Hoan Nguyen, Hsinchu City (TW); David S. H. Wong, Hsinchu City (TW); Shi-Shang Jang, Hsinchu City (TW)

(73) Assignee: National Tsing Hua University, Hsinchu City (TW)

(21) Appl. No.: 15/730,739

(22) Filed: Oct. 12, 2017

(30) Foreign Application Priority Data
Jul. 27, 2017 (TW) 106125238

(51) Int. Cl. B01D 53/14; C01B 32/50

(52) U.S. Cl. CPC B01D 53/1475; B01D 3/06; C01B 32/50

(57) ABSTRACT

A system and a method for capturing carbon dioxide (CO₂) used for capturing CO₂ of a CO₂-containing gas are provided. The system for capturing CO₂ includes at least one CO₂ absorption tower, a stripper, a first flash drum, and a compressor. The CO₂ absorption tower has an absorbent. The stripper is connected to a liquid outlet of the CO₂ absorption tower. The first flash drum is connected to a liquid outlet of the stripper. The compressor is connected between a gas outlet of the first flash drum and a gas inlet of the stripper.

### CROSS-REFERENCE TO RELATED APPLICATION

This application claims the priority benefit of Taiwan application serial no. 106125238, filed on Jul. 27, 2017. The entirety of the above-mentioned patent application is hereby incorporated by reference herein and made a part of this specification.

### BACKGROUND OF THE INVENTION

### Field of the Invention

The invention relates to a capture system and method, and more particularly, to a system and a method for capturing carbon dioxide.

### Description of Related Art

Since the industrial revolution, the large amount of flue gas produced by the humans from burning fossil fuel has caused the concentration of carbon dioxide (CO₂) in the atmosphere to rapidly increase. Since CO₂ is the main greenhouse gas, rapidly increased CO₂ concentrations cause global warming as a result. In the past few years, to reduce damage to the environment from CO₂, a system for capturing CO₂ has been developed, including a CO₂ absorption tower and a stripper that can capture CO₂ in flue gas via a chemical absorption method.

In the known system for capturing CO₂, a reboiler is needed to heat the stripper. However, the stripping treatment heating the stripper via a reboiler produces significant energy penalty.

### SUMMARY OF THE INVENTION

The invention provides a system and a method for capturing carbon dioxide (CO₂) that can effectively reduce energy penalty produced during the capture of CO₂.

The invention provides a system for capturing CO₂ used for capturing CO₂ in a CO₂-containing gas. The system for capturing CO₂ includes at least one CO₂ absorption tower, a stripper, a first flash drum, and a compressor. The CO₂ absorption tower has an absorbent. The stripper is connected to a liquid outlet of the CO₂ absorption tower. The first flash drum is connected to a liquid outlet of the stripper. The compressor is connected between a gas outlet of the first flash drum and a gas inlet of the stripper.

According to an embodiment of the invention, in the system for capturing CO₂, the CO₂-containing gas is, for instance, flue gas.

According to an embodiment of the invention, in the system for capturing CO₂, the absorbent can include ammonia water having a concentration of, for instance, 3 mole % to 10 mole %.

According to an embodiment of the invention, in the system for capturing CO₂, the pressure of the stripper can be greater than the pressure of the first flash drum.

According to an embodiment of the invention, in the system for capturing CO₂, the pressure of the stripper can be 8.7 bars to 10.5 bars. The pressure of the first flash drum can be 2.8 bars to 4.5 bars.

According to an embodiment of the invention, in the system for capturing CO₂, when the number of the CO₂ absorption tower is a plurality, the CO₂ absorption tower can include an N number of CO₂ absorption towers, and N is an integer greater than 1. The N number of CO₂ absorption towers can be connected in series in order.

According to an embodiment of the invention, in the system for capturing CO₂, a cooling section can be further included. The cooling section is connected between a liquid outlet of the first CO₂ absorption tower and a liquid inlet of the N-th CO₂ absorption tower in the N number of CO₂ absorption towers.

According to an embodiment of the invention, in the system for capturing CO₂, a mixer can be further included. The mixer is connected between the liquid outlet of the CO₂ absorption tower and a liquid inlet of the stripper and used for mixing a rich solvent from the CO₂ absorption tower and water.

According to an embodiment of the invention, in the system for capturing CO₂, a condensation section can be further included. The condensation section is connected to a gas outlet of the stripper.

According to an embodiment of the invention, in the system for capturing CO₂, a second flash drum can be further included. The second flash drum is connected to the condensation section.

According to an embodiment of the invention, in the system for capturing CO₂, the liquid outlet of the first flash drum can be connected to a reflow liquid inlet of the CO₂ absorption tower.

According to an embodiment of the invention, in the system for capturing CO₂, a heat exchange section can be further included. The heat exchange section is connected between the liquid outlet of the CO₂ absorption tower and a liquid inlet of the stripper via a first flow path and connected between the liquid outlet of the first flash drum and the reflow liquid inlet of the CO₂ absorption tower via a second flow path.

According to an embodiment of the invention, in the system for capturing CO₂, a cooling section can be further included. The cooling section is connected between the heat exchange section and the reflow liquid inlet of the CO₂ absorption tower.

The invention provides a method for capturing CO₂ including the following steps. A CO₂ absorption treatment is performed on a CO₂-containing gas using an absorbent in at least one CO₂ absorption tower to form a rich solvent. A first flash treatment is performed on a liquid from a stripper using a first flash drum to form steam and a liquid after the first flash treatment. The steam is transferred to the stripper using a compressor. In the stripper, a stripping treatment is performed on the rich solvent from the CO₂ absorption tower using the steam to form a CO₂ stripping gas and a lean solvent.

According to an embodiment of the invention, in the method for capturing CO₂, the absorbent is, for instance, ammonia water having a concentration of 3 mole % to 10 mole %.

According to an embodiment of the invention, in the method for capturing CO₂, the pressure of the stripper can be greater than the pressure of the first flash drum.

According to an embodiment of the invention, in the method for capturing CO₂, the pressure of the stripper can be 8.7 bars to 10.5 bars. The pressure of the first flash drum can be 2.8 bars to 4.5 bars.

According to an embodiment of the invention, in the method for capturing CO₂, when the number of the CO₂ absorption tower is a plurality, the CO₂ absorption tower can include an N number of CO₂ absorption towers, and N is an integer greater than 1. The N number of CO₂ absorption towers can be connected in series in order.

According to an embodiment of the invention, in the method for capturing CO₂, the rich solvent from the first CO₂ absorption tower can be further cooled and the cooled rich solvent can be returned to the N-th CO₂ absorption tower.

According to an embodiment of the invention, in the method for capturing CO₂, the rich solvent and the water can be further mixed.

According to an embodiment of the invention, in the method for capturing CO₂, the CO₂ stripping gas can be further condensed to form a condensed CO₂ stripping gas.

According to an embodiment of the invention, in the method for capturing CO₂, a second flash treatment can be further performed on the condensed CO₂ stripping gas using a second flash drum to form a CO₂ flash gas.

According to an embodiment of the invention, in the method for capturing CO₂, the liquid after the first flash treatment can include a lean solvent.

According to an embodiment of the invention, in the method for capturing CO₂, a heat exchange treatment can be further performed on the rich solvent and the lean solvent after the first flash treatment in a heat exchange section.

According to an embodiment of the invention, in the method for capturing CO₂, the lean solvent after the heat exchange treatment can be further cooled.

Based on the above, the system and method for capturing CO₂ provided by the invention can provide the steam produced by the first flash drum to the stripper via a compressor to perform a stripping treatment on the rich solvent in the stripper, and therefore the system and method for capturing CO₂ can effectively capture CO₂. Moreover, since the first flash drum can be used to replace the reboiler, energy penalty produced during the capture of CO₂ can be effectively reduced.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic of a system for capturing carbon dioxide of an embodiment of the invention.

FIG. 2 is a schematic of a system for capturing carbon dioxide of another embodiment of the invention.

FIG. 3 is a flow chart of a method for capturing carbon dioxide of an embodiment of the invention.

### DESCRIPTION OF THE EMBODIMENTS

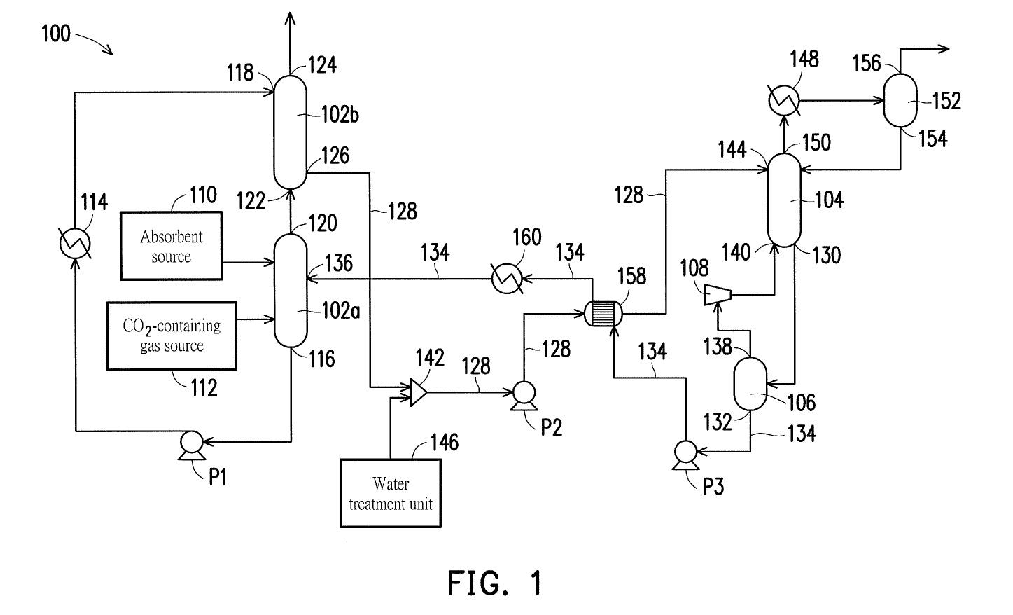

FIG. 1 is a schematic of a system for capturing carbon dioxide (CO₂) of an embodiment of the invention.

Referring to FIG. 1, a system 100 for capturing CO₂ can be used for capturing CO₂ in a CO₂-containing gas. The system 100 for capturing CO₂ includes a CO₂ absorption tower 102a, a CO₂ absorption tower 102b, a stripper 104, a first flash drum 106, and a compressor 108. Moreover, the system 100 for capturing CO₂ can further include an absorbent source 110 and a CO₂-containing gas source 112.

The absorbent source 110 is connected to the CO₂ absorption tower 102a and provides an absorbent to the CO₂ absorption tower 102a. The absorbent is, for instance, ammonia water having a concentration of 3 mole % to 10 mole %.

The CO₂-containing gas source 112 is connected to the CO₂ absorption tower 102a and provides a CO₂-containing gas to the CO₂ absorption tower 102a. The CO₂-containing gas is, for instance, flue gas. The flue gas contains, for instance, 5 mole % to 30 mole % of CO₂.

The CO₂ absorption tower 102a and the CO₂ absorption tower 102b have the absorbent. The CO₂ absorption tower 102a and the CO₂ absorption tower 102b are connected in series. In the CO₂ absorption tower 102a and the CO₂ absorption tower 102b, a CO₂ absorption treatment can be performed on the CO₂-containing gas using an absorbent to form a rich solvent and a gas after the CO₂ absorption treatment. In the present embodiment, the rich solvent obtained from the CO₂ absorption treatment is a solvent having a high CO₂ concentration. The rich solvent is, for instance, a solution containing CO₂ and ammonia water, wherein the molar ratio of the CO₂ and the ammonia water is, for instance, 0.1 to 0.41.

In the present embodiment, the system 100 for capturing CO₂ includes two CO₂ absorption towers (102a and 102b) as an example, but the invention is not limited thereto. Any system 100 for capturing CO₂ including at least one CO₂ absorption tower is within the scope of the invention. That is, the number of the CO₂ absorption tower can be one or a plurality.

Moreover, when a number of the CO₂ absorption tower is a plurality, the system 100 for capturing CO₂ can include an N number of CO₂ absorption towers, and N is an integer greater than 1, wherein the N number of CO₂ absorption towers are connected in series in order. At this point, the system 100 for capturing CO₂ can include a cooling section 114. The cooling section 114 is connected between a liquid outlet of the first CO₂ absorption tower and a liquid inlet of the N-th CO₂ absorption tower in the N number of CO₂ absorption towers. Therefore, the rich solvent from the first CO₂ absorption tower can be cooled by the cooling section 114 and the cooled rich solvent can be returned to the N-th CO₂ absorption tower. In the present embodiment, N is equal to 2 as an example. In other embodiments, N can also be an integer of 3 or more.

For instance, in the present embodiment, the cooling section 114 is connected between a liquid outlet 116 of the CO₂ absorption tower 102a and a liquid inlet 118 of the CO₂ absorption tower 102b. Therefore, after the absorbent source 110 provides an absorbent to the CO₂ absorption tower 102a, the rich solvent from the CO₂ absorption tower 102a can be transferred to the cooling section 114 by a pump P1. The cooling section 114 can cool the rich solvent from the CO₂ absorption tower 102a and return the cooled rich solvent to the CO₂ absorption tower 102b to continue the CO₂ absorption treatment.

Moreover, the CO₂-containing gas from the CO₂-containing gas source 112 first enters the CO₂ absorption tower 102a for a CO₂ absorption treatment, then enters the CO₂ absorption tower 102b via a gas outlet 120 of the CO₂ absorption tower 102a and a gas inlet 122 of the CO₂ absorption tower 102b for another CO₂ absorption treatment, and then the gas after the CO₂ absorption treatment is discharged from a gas outlet 124 of the CO₂ absorption tower 102b.

The stripper 104 is connected to a liquid outlet 126 of the CO₂ absorption tower 102b. For instance, the rich solvent flowing out of the liquid outlet 126 of the CO₂ absorption tower 102b can be transferred to the stripper 104 by a pump P2 disposed on a first flow path 128. In the stripper 104, a stripping treatment can be performed on the rich solvent from the CO₂ absorption tower 102b to form a CO₂ stripping gas and a lean solvent. In the present embodiment, the lean solvent obtained from the stripping treatment is a solvent having a low CO₂ concentration.

The first flash drum 106 is connected to a liquid outlet 130 of the stripper 104. A first flash treatment can be performed on the liquid from the stripper 104 using the first flash drum 106 to form steam and a liquid after the first flash treatment. The pressure of the stripper 104 can be greater than the pressure of the first flash drum 106. For instance, the pressure of the stripper 104 can be 8.7 bars to 10.5 bars, and the pressure of the first flash drum 106 can be 2.8 bars to 4.5 bars.

When the system 100 for capturing CO₂ is initially in operation, since the stripper 104 does not have steam (i.e., a stripping treatment is not performed yet) therein, the liquid provided to the first flash drum 106 from the stripper 104 can be a rich solvent. After the system 100 for capturing CO₂ is operated for a period of time, since the first flash drum 106 begins to provide steam to the stripper 104 and a stripping treatment is performed on the rich solvent by the steam, the liquid provided to the first flash drum 106 by the stripper 104 can be a lean solvent. Moreover, after the system 100 for capturing CO₂ is operated for a period of time (i.e., after the first flash drum 106 begins to provide steam to the stripper 104), the liquid after the first flash treatment includes a lean solvent.

Moreover, a liquid outlet 132 of the first flash drum 106 can be connected to a reflow liquid inlet 136 of the CO₂ absorption tower 102a via a second flow path 134. Specifically, the liquid after the first flash treatment (the liquid from the first flash drum 106) can be returned to the CO₂ absorption tower 102a via a pump P3 disposed on the second flow path 134.

The compressor 108 is connected between a gas outlet 138 of the first flash drum 106 and a gas inlet 140 of the stripper 104 and can be used for transferring the steam produced by the first flash drum 106 to the stripper 104.

The system 100 for capturing CO₂ can further include a mixer 142. The mixer 142 can be connected between the liquid outlet 126 of the CO₂ absorption tower 102b and a liquid inlet 144 of the stripper 104 via the first flow path 128. Before the rich solvent flows to the stripper 104, the mixer 142 can mix the rich solvent from the CO₂ absorption tower 102b and water to form a rich solvent having a balanced mass. The water is from, for instance, a water treatment unit 146. The mixing ratio of the rich solvent and the water is, for instance, 1000:1.

The system 100 for capturing CO₂ can further include a condensation section 148. The condensation section 148 is connected to a gas outlet 150 of the stripper 104. The condensation section 148 can receive the CO₂ stripping gas from the stripper 104 and condense the CO₂ stripping gas to form a condensed CO₂ stripping gas. Via condensation, water in the CO₂ stripping gas can be removed, and therefore the water content of the condensed CO₂ stripping gas is very small.

The system 100 for capturing CO₂ can further include a second flash drum 152. The second flash drum 152 is connected to the condensation section 148. The second flash drum 152 can receive the condensed CO₂ stripping gas from the condensation section 148 and perform a second flash treatment on the condensed CO₂ stripping gas to further remove excess water and form a CO₂ flash gas containing a high concentration of CO₂. A liquid outlet 154 of the second flash drum 152 is connected to the stripper 104 and can return the water produced by the second flash drum 152 to the stripper 104. The CO₂ flash gas produced by the second flash drum 152 can be discharged from a gas outlet 156 of the second flash drum 152 and high-concentration CO₂ in the CO₂ flash gas can be reused.

The system 100 for capturing CO₂ can further include a heat exchange section 158. The heat exchange section 158 is connected between the liquid outlet 126 of the CO₂ absorption tower 102b and the liquid inlet 144 of the stripper 104 via the first flow path 128 and connected between the liquid outlet 132 of the first flash drum 106 and the reflow liquid inlet 136 of the CO₂ absorption tower 102a via the second flow path 134, wherein the rich solvent in the first flow path 128 is a cold fluid, and the lean solvent in the second flow path 134 is a hot fluid. Accordingly, a heat exchange treatment can be performed on the rich solvent and the lean solvent obtained after the first flash treatment in the heat exchange section 158. Specifically, after the heat exchange treatment is performed, the temperature of the rich solvent can be increased and the temperature of the lean solvent can be reduced.

The system 100 for capturing CO₂ can further include a cooling section 160. The cooling section 160 is connected between the heat exchange section 158 and the reflow liquid inlet 136 of the CO₂ absorption tower 102a. The cooling section 160 can cool the lean solvent after the heat exchange treatment.

It can be known from the above embodiments that, the system 100 for capturing CO₂ can provide the steam produced by the first flash drum 106 to the stripper 104 via the compressor 108 to perform a stripping treatment on the rich solvent in the stripper 104, and therefore the system 100 for capturing CO₂ can effectively capture CO₂. Moreover, since the first flash drum 106 can be used to replace the reboiler, energy penalty produced during the capture of CO₂ can be effectively reduced.

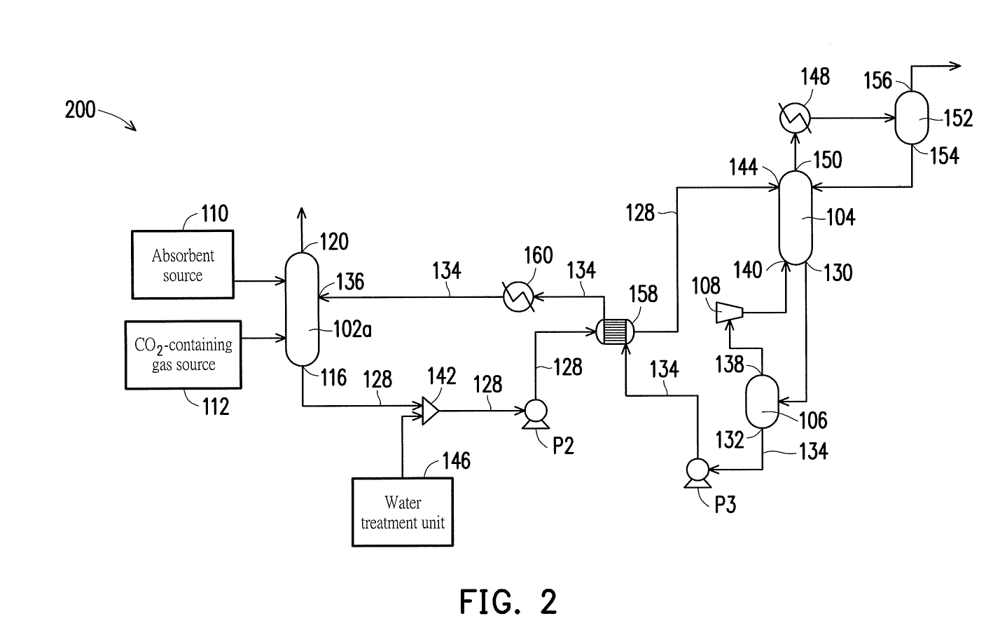

FIG. 2 is a schematic of a system for capturing CO₂ of another embodiment of the invention.

Referring to both FIG. 1 and FIG. 2, the differences of a system 200 for capturing CO₂ of FIG. 2 and the system 100 for capturing CO₂ 100 of FIG. 1 are as follows. The number of the CO₂ absorption tower in the system 200 for capturing CO₂ is one, i.e., the CO₂ absorption tower in the system 200 for capturing CO₂ only has the CO₂ absorption tower 102a. In the CO₂ absorption tower 102a, the gas after the CO₂ absorption treatment is discharged from the gas outlet 120 of the CO₂ absorption tower 102a. The stripper 104 is connected to the liquid outlet 116 of the CO₂ absorption tower 102a. Moreover, the system 200 for capturing CO₂ does not include the cooling section 114 in FIG. 1. Moreover, the same components in FIG. 2 and FIG. 1 are represented by the same reference numerals and are not repeated herein.

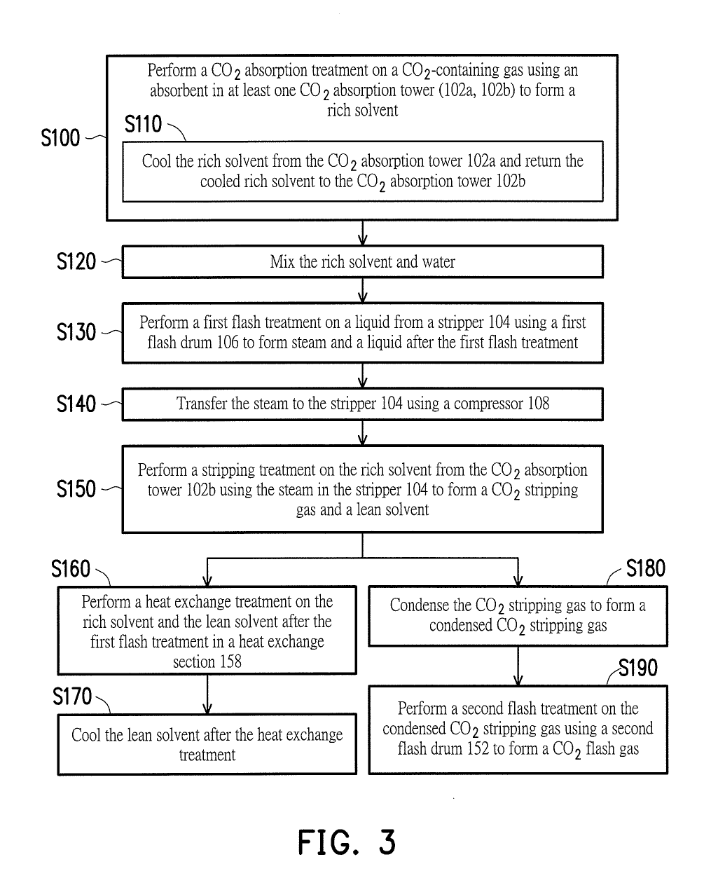

FIG. 3 is a flow chart of a method for capturing CO₂ of an embodiment of the invention. In the method for capturing CO₂ of the present embodiment, the system 100 for capturing CO₂ of FIG. 1 is used for explanation, but the invention is not limited thereto. In another embodiment, the method for capturing CO₂ can also adopt the system 200 for capturing CO₂ of FIG. 2. Detailed descriptions of each component in FIG. 1 are as provided in the embodiments above and are not repeated herein.

Referring to FIG. 1 and FIG. 3, step S100 is performed to perform a CO₂ absorption treatment on a CO₂-containing gas using an absorbent in at least one CO₂ absorption tower (102a, 102b) to form a rich solvent. For instance, in the CO₂ absorption tower 102a and the CO₂ absorption tower 102b, a CO₂ absorption treatment is performed on the CO₂-containing gas using an absorbent. The absorbent is, for instance, ammonia water having a concentration of 3 mole % to 10 mole %.

Step S110 can be optionally performed to cool the rich solvent from the CO₂ absorption tower 102a and return the cooled rich solvent to the CO₂ absorption tower 102b. For instance, the rich solvent from the CO₂ absorption tower 102a can be cooled using the cooling section 114.

Step S120 can be optionally performed to mix the rich solvent and water. For instance, the rich solvent and the water can be mixed by the mixer 142 at a specific mixing ratio (such as 1000:1) to form a rich solvent having a balanced mass. The water is, for instance, from the water treatment unit 146 in FIG. 1.

Step S130 is performed to perform a first flash treatment on a liquid from the stripper 104 using the first flash drum 106 to form steam and a liquid after the first flash treatment. The pressure of the stripper 104 can be greater than the pressure of the first flash drum 106. For instance, the pressure of the stripper 104 can be 8.7 bars to 10.5 bars, and the pressure of the first flash drum 106 can be 2.8 bars to 4.5 bars. After a period of operation of the system 100 for capturing CO₂, the liquid after the first flash treatment includes a lean solvent.

Step S140 is performed to transfer the steam to the stripper 104 using the compressor 108.

Step S150 is performed to perform a stripping treatment on the rich solvent from the CO₂ absorption tower 102b using the steam in the stripper 104 to form a CO₂ stripping gas and a lean solvent.

Step S160 can be optionally performed to perform a heat exchange treatment on the rich solvent and the lean solvent after the first flash treatment in the heat exchange section 158. After the heat exchange treatment is performed, the temperature of the rich solvent after the heat exchange treatment can be increased, and the temperature of the lean solvent after the heat exchange treatment can be reduced.

Step S170 can be optionally performed to cool the lean solvent after the heat exchange treatment. For instance, the lean solvent after the heat exchange treatment can be cooled by the cooling section 160.

Step S180 can be optionally performed to condense the CO₂ stripping gas to form a condensed CO₂ stripping gas. For instance, the CO₂ stripping gas can be condensed by the condensation section 148 to form a condensed CO₂ stripping gas. Via condensation, water in the CO₂ stripping gas can be removed, and therefore the water content of the condensed CO₂ stripping gas is very small.

Step S190 can be optionally performed to perform a second flash treatment on the condensed CO₂ stripping gas using a second flash drum 152 to form a CO₂ flash gas. Via the second flash treatment, excess water can be further removed such that the CO₂ flash gas contains a high concentration of CO₂. Moreover, the water produced by the second flash drum 152 can be returned to the stripper 104.

It can be known from the above embodiments that, in the method for capturing CO₂, the steam produced by the first flash drum 106 can be provided to the stripper 104 via the compressor 108 to perform a stripping treatment on the rich solvent in the stripper 104, and therefore the method for capturing CO₂ can effectively capture CO₂. Moreover, since the first flash drum 106 can be used to replace the reboiler, energy penalty produced during the capture of CO₂ can be effectively reduced.

In the following, a system and method for capturing CO₂ of the invention are adopted to provide specific experimental examples of the embodiments of the invention to confirm the efficacy of the embodiments of the invention, but the scope of the invention is not limited to the following content.

### EXPERIMENTAL EXAMPLES

### Experimental Example 1

In experimental example 1, the system 100 for capturing CO₂ shown in FIG. 1 was used to capture CO₂ in a CO₂-containing gas.

In experimental example 1, the pressure of the stripper 104 was set to 10.5 bars and the pressure of the first flash drum 106 was set to 3.82 bars. The absorbent provided from the absorbent source 110 to the CO₂ absorption tower 102a was ammonia water having a concentration of about 5.5 mole %. A CO₂ absorption treatment was performed on the CO₂-containing gas using the absorbent to obtain a rich solvent. In the rich solvent, the molar ratio of CO₂ and ammonia water was 0.408. After a stripping treatment was performed on the rich solvent via the stripper 104, a lean solvent was obtained. In the lean solvent after the treatment of the first flash drum 106, the molar ratio of CO₂ and ammonia water was 0.25. The lean solvent contained ammonia water having a concentration of 5.5 mole %.

The experimental results of experimental example 1 are provided in Table 1.

TABLE 1

| | Experimental |
|---|---|
| | example 1 |
| CO₂ removal rate (%) | 89.6 |
| Reboiler duty (MWh/CO₂ capture amount (tons)) | 0 |
| Temperature (° C.) of reboiler | No reboiler |
| Compression work (MWh/CO₂ capture amount | 0.109 |
| (tons)) | |
| Equivalent work (MWh/CO₂ capture amount (tons)) | 0.109 |
| Energy penalty (%) | 9.81 |

### Experimental Example 2

In experimental example 2, the system 100 for capturing CO₂ shown in FIG. 1 was used to capture CO₂ in a CO₂-containing gas.

In experimental example 2, the pressure of the stripper 104 was set to 10 bars and the pressure of the first flash drum 106 was set to 2.82 bars. The absorbent provided from the absorbent source 110 to the CO₂ absorption tower 102a was ammonia water having a concentration of about 6.8 mole %. A CO₂ absorption treatment was performed on the CO₂-containing gas using the absorbent to obtain a rich solvent. In the rich solvent, the molar ratio of CO₂ and ammonia water was 0.367. After a stripping treatment was performed on the rich solvent via the stripper 104, a lean solvent was obtained. In the lean solvent after the treatment of the first flash drum 106, the molar ratio of CO₂ and ammonia water was 0.15. The lean solvent contained ammonia water having a concentration of 6.8 mole %.

The experimental results of experimental example 2 are provided in Table 2.

TABLE 2

| | Experimental |
|---|---|
| | example 2 |
| CO₂ removal rate (%) | 89.8 |
| Reboiler duty (MWh/CO₂ capture amount (tons)) | 0 |
| Temperature (° C.) of reboiler | No reboiler |
| Compression work (MWh/CO₂ capture amount | 0.202 |
| (tons)) | |
| Equivalent work (MWh/CO₂ capture amount (tons)) | 0.202 |
| Energy penalty (%) | 18.2 |

### Experimental Example 3

In experimental example 3, the system 100 for capturing CO₂ shown in FIG. 1 was used to capture CO₂ in a CO₂-containing gas.

In experimental example 3, the pressure of the stripper 104 was set to 8.7 bars and the pressure of the first flash drum 106 was set to 3.4 bars. The absorbent provided from the absorbent source 110 to the CO₂ absorption tower 102a was ammonia water having a concentration of about 10 mole %. A CO₂ absorption treatment was performed on the CO₂-containing gas using the absorbent to obtain a rich solvent. In the rich solvent, the molar ratio of CO₂ and ammonia water was 0.391. After a stripping treatment was performed on the rich solvent via the stripper 104, a lean solvent was obtained. In the lean solvent after the treatment of the first flash drum 106, the molar ratio of CO₂ and ammonia water was 0.30. The lean solvent contained ammonia water having a concentration of 10 mole %.

The experimental results of experimental example 3 are provided in Table 3.

TABLE 3

| | Experimental |
|---|---|
| | example 3 |
| CO₂ removal rate (%) | 83.1 |
| Reboiler duty (MWh/CO₂ capture amount (tons)) | 0 |
| Temperature (° C.) of reboiler | No reboiler |
| Compression work (MWh/CO₂ capture amount | 0.101 |
| (tons)) | |
| Equivalent work (MWh/CO₂ capture amount (tons)) | 0.101 |
| Energy penalty (%) | 9.12 |

It can be known from experimental example 1 to experimental example 3 that, the CO₂ removal rate of the system for capturing CO₂ is greater than 83% and the energy penalty thereof is less than 20%. Therefore, since in the systems for capturing CO₂ of experimental example 1 to experimental example 3, the reboiler is replaced by the first flash drum 106, energy penalty can be effectively reduced.

Based on the above, via the system and method for capturing CO₂ of the embodiments, CO₂ in the CO₂-containing gas can be effectively captured and energy penalty produced during the capture of CO₂ can be reduced.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A system for capturing carbon dioxide (CO₂) used for capturing CO₂ in a CO₂-containing gas, wherein the system for capturing CO₂ comprises:
at least one CO₂ absorption tower having an absorbent;
a stripper connected to a liquid outlet of the at least one CO₂ absorption tower;
a first flash drum connected to a liquid outlet of the stripper; and
a compressor connected between a gas outlet of the first flash drum and a gas inlet of the stripper.

2. The system for capturing CO₂ of claim 1, wherein the CO₂-containing gas comprises a flue gas.

3. The system for capturing CO₂ of claim 1, wherein the absorbent comprises an ammonia water having a concentration of 3 mole % to 10 mole %.

4. The system for capturing CO₂ of claim 1, wherein a pressure of the stripper is greater than a pressure of the first flash drum.

5. The system for capturing CO₂ of claim 4, wherein the pressure of the stripper is 8.7 bars to 10.5 bars, and the pressure of the first flash drum is 2.8 bars to 4.5 bars.

6. The system for capturing CO₂ of claim 1, wherein when a number of the at least one CO₂ absorption tower is a plurality, the system for capturing CO₂ comprises an N number of CO₂ absorption towers, and N is an integer greater than 1, wherein the N number of CO₂ absorption towers are connected in series in order.

7. The system for capturing CO₂ of claim 6, further comprising a cooling section connected between a liquid outlet of a first CO₂ absorption tower and a liquid inlet of an N-th CO₂ absorption tower in the N number of CO₂ absorption towers.

8. The system for capturing CO₂ of claim 1, further comprising a mixer connected between the liquid outlet of the at least one CO₂ absorption tower and a liquid inlet of the stripper and used for mixing a rich solvent from the at least one CO₂ absorption tower and a water.

9. The system for capturing CO₂ of claim 1, further comprising a condensation section connected to a gas outlet of the stripper.

10. The system for capturing CO₂ of claim 9, further comprising a second flash drum connected to the condensation section.

11. The system for capturing CO₂ of claim 1, wherein a liquid outlet of the first flash drum is connected to a reflow liquid inlet of the at least one CO₂ absorption tower.

12. The system for capturing CO₂ of claim 11, further comprising a heat exchange section connected between the liquid outlet of the at least one CO₂ absorption tower and a liquid inlet of the stripper via a first flow path and connected between the liquid outlet of the first flash drum and the reflow liquid inlet of the at least one CO₂ absorption tower via a second flow path.

13. The system for capturing CO₂ of claim 12, further comprising a cooling section connected between the heat exchange section and the reflow liquid inlet of the at least one CO₂ absorption tower.

14. A method for capturing CO₂, comprising:
performing a CO₂ absorption treatment on a CO₂-containing gas using an absorbent in at least one CO₂ absorption tower to form a rich solvent;
performing a first flash treatment on a liquid from a stripper using a first flash drum to form a steam and a liquid after the first flash treatment;
transferring the steam to the stripper using a compressor; and
performing a stripping treatment on the rich solvent from the at least one CO₂ absorption tower using the steam in the stripper to form a CO₂ stripping gas and a lean solvent.

15. The method for capturing CO₂ of claim 14, wherein the absorbent comprises an ammonia water having a concentration of 3 mole % to 10 mole %.

16. The method for capturing CO₂ of claim 14, wherein a pressure of the stripper is greater than a pressure of the first flash drum.

17. The method for capturing CO₂ of claim 16, wherein the pressure of the stripper is 8.7 bars to 10.5 bars, and the pressure of the first flash drum is 2.8 bars to 4.5 bars.

18. The method for capturing CO₂ of claim 14, wherein when a number of the at least one CO₂ absorption tower is a plurality, the at least one CO₂ absorption tower comprises an N number of CO₂ absorption towers, and N is an integer greater than 1, wherein the N number of CO₂ absorption towers are connected in series in order.

19. The method for capturing CO₂ of claim 18, further comprising cooling the rich solvent from a first CO₂ absorption tower and returning the cooled rich solvent to an N-th CO₂ absorption tower.

20. The method for capturing CO₂ of claim 14, further comprising mixing the rich solvent and a water.

21. The method for capturing CO₂ of claim 14, further comprising condensing the CO₂ stripping gas to form a condensed CO₂ stripping gas.

22. The method for capturing CO₂ of claim 21, further comprising performing a second flash treatment on the condensed CO₂ stripping gas using a second flash drum to form a CO₂ flash gas.

23. The method for capturing CO₂ of claim 14, wherein the liquid after the first flash treatment comprises the lean solvent.

24. The method for capturing CO₂ of claim 23, further comprising performing a heat exchange treatment on the rich solvent and the lean solvent after the first flash treatment in a heat exchange section.

25. The method for capturing CO₂ of claim 24, further comprising cooling the lean solvent after the heat exchange treatment.
